(19) United States
(12) Patent Application Publication
(10) Pub. No.: US 2016/0289247 A1
(43) Pub. Date: Oct. 6, 2016

(54) SILYLATED CYCLIC PHOSPHONAMIDES

(71) Applicant: WACKER CHEMIE AG, München (DE)

(72) Inventors: Andreas BOCKHOLT, Muenchen (DE); Peter GIGLER, Dachau (DE)

(21) Appl. No.: 15/038,322

(22) PCT Filed: Nov. 21, 2014
(86) PCT No.: PCT/EP2014/075312

§ 371 Date: May 20, 2016

(30) Foreign Application Priority Data
Nov. 26, 2013 (DE) 10 2013 224 159.3

(51) Int. Cl. C07F 7/08; H01M 10/0568; H01M 10/0569; H01M 10/0525; H01M 10/0567

(52) U.S. Cl. CPC C07F 7/082; C07F 7/083; H01M 10/0525; H01M 10/0567; H01M 10/0569; H01M 10/0568

(57) ABSTRACT

The invention relates to silylated cyclic phosphonamides of the general formula (1) in which R¹ represents an unsubstituted or fluoro-substituted alkyl group with 1-20 carbon atoms, R², R³ each represent an unsubstituted or fluoro-substituted alkyl or alkyl group with 1-20 carbon atoms or a siloxy group with 1-20 silicon atoms, wherein two or three of the groups R¹, R², R³ can be connected to each other, R4 represents an unsubstituted or fluoro-substituted alkyl group with 1-20 carbon atoms, and n represents the values 1 or 2. The invention also relates to a method for producing the phosophonamides of the general formula (1), to diamines used during the production of the phosphonamides, to an electrolyte which contains the phosphonamides of the general formula (1), and to a lithium-ion battery which comprises a cathode, an anode, a separator, and the electrolyte.

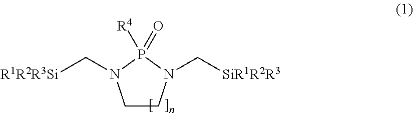

The invention relates to silylated cyclic phosphonamides, the preparation thereof, diamines used in the preparation of the phosphonamides, an electrolyte containing the phosphonamides and also a lithium ion battery comprising the electrolyte.

Lithium ion batteries are among the most promising systems for mobile applications. The fields of use extend from high-value electronic appliances through to batteries for electrically powered motor vehicles.

The energy densities of lithium ion batteries have to be significantly improved further in order for this battery technology to be able to be used in further fields of application. One possible way of increasing the energy density is the use of so-called high-voltage cathode materials having potentials of >4.4 V relative to Li/Li+. The use of these materials significantly increases the cell voltage and thus the energy density. However, the stability of the electrolytes used today is not sufficient in the case of cathode materials having these potentials to be able to achieve a long cycling life of the cells. Present-day electrolytes based on organic carbonates are oxidized at potentials of >4.4 V to form gaseous products such as CO₂, so that the cell becomes depleted in electrolyte and an ever greater internal resistance is thus built up, ultimately leading to a decrease in capacity and failure of the cell. In addition, the evolution of gas leads to an undesirable pressure increase in the cell.

EP 2573854 A1 describes silylated phosphonic esters as electrolyte additive for Li ion batteries. In contrast to the unsilylated analogs and conventional additives such as vinylene carbonate, the silylated phosphonic ester is able to reduce the cell resistance and increase the high-temperature storage stability.

US 2013/0250485 A1 describes the use of tris(trimethylsilyl) phosphate as electrolyte additive for supercapacitors, which forms a film on the carbon cathode and thus leads to increased high-voltage stability.

In “Zhurnal Obshchei Khimii (1987), 57, (2), 311-21”, Kurochkin et al. describe various ways of synthesizing N,N′-bis(trimethylsilyl)-N,N′-trimethylenemethylphosphonic diamide. One possibility is the reaction of N,N′-bis(trimethylsilyl)-1,3-propanediamine with bis(dimethylamino)methoxyphosphine.

The invention provides silylated cyclic phosphonamides of the general formula 1

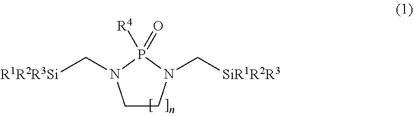

where
R¹ is an unsubstituted or fluorine-substituted alkyl radical having 1-20 carbon atoms,
R², R³ are each an unsubstituted or fluorine-substituted alkyl or alkoxy radical having 1-20 carbon atoms or a siloxy radical having 1-20 silicon atoms, where two or three of the radicals R¹, R², R³ can be joined to one another,
R⁴ is an unsubstituted or fluorine-substituted alkyl radical having 1-20 carbon atoms and
n is 1 or 2.

As a result of the addition of phosphonamide of the general formula 1 as additive to the electrolyte of a lithium ion battery, a protective layer (solid electrolyte interface, SEI) is formed on the cathode material and this greatly reduces further oxidation of the electrolyte. A longer cycling life of the cells is achieved as a result. At the same time, the conductivity of the electrolytes is not adversely affected.

Examples of unsubstituted alkyl radicals R¹, R², R³, R⁴ are the methyl, ethyl, n-propyl, isopropyl, n-butyl, isobutyl, tert-butyl, n-pentyl, isopentyl, neopentyl, tert-pentyl radical, hexyl radicals such as the n-hexyl radical, heptyl radicals such as the n-heptyl radical, octyl radicals such as the n-octyl radical and isooctyl radicals such as the 2,2,4-trimethylpentyl radical, nonyl radicals such as the n-nonyl radical, decyl radicals such as the n-decyl radical, dodecyl radicals such as the n-dodecyl radical. Examples of fluorine-substituted alkyl radicals are trifluoromethyl, 3,3,3-trifluoropropyl and 5,5,5,4,4,3,3-heptafluoropentyl radicals. Preferred alkyl radicals R¹, R², R³, R⁴ have 1-10 carbon atoms. Examples of alkoxy radicals R², R³ are the methoxy, ethoxy, n-propoxy, isopropoxy, n-butoxy and isobutoxy radicals.

Preferred alkyl radicals and alkoxy radicals R¹, R², R³, R⁴ have 1-10 carbon atoms. Particular preference is given to the methyl, ethyl, n-propyl, isopropyl, methoxy and ethoxy radicals. Particularly preferred radicals R¹, R², R³, R⁴ are in each case the methyl, ethyl, n-propyl and isopropyl radicals.

The siloxy radical can be a silyl radical, for example trimethylsilyl radical, or a siloxanyl radical which preferably has up to 10 silicon atoms.

When two or three of the radicals R¹, R², R³ are joined to one another, these can form a monocyclic or bicyclic alkyl or siloxane ring.

n is preferably 2.

Particular preference is given to N,N′-bis(trimethylsilylmethyl)-N,N′-trimethylenemethylphosphonic diamide.

The invention likewise provides a process for preparing the silylated cyclic phosphonamides of the general formula 1

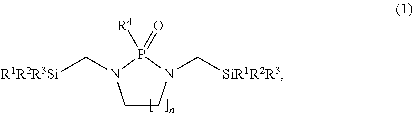

wherein diamines of the general formula 2

R¹R²R³Si—NH—CH₂—(CH₂)ₙ—NH—SiR¹R²R³ (2)

are reacted with a phosphonic dihalide of the general formula 3

R⁴POX₂ (3),

where

X is fluorine, chloride or bromine and

R¹, R², R³, R⁴ and n are as defined above.

X is preferably chlorine.

A base, in particular a strong base, is preferably used in the reaction. Preferred bases are amines such as monoamines, e.g. octylamine, nonylamine, decylamine, undecylamine, dodecylamine (laurylamine), tridecylamine, tridecylamine (isomer mixture), tetradecylamine (myristylamine), pentadecylamine, hexadecylamine (cetylamine), heptadecylamine, octadecylamine, and polyamines, e.g. ethylenediamine, diethylenetriamine, triethylenetetramine, tetraethylenepentamine, pentaethylenehexamine, hexaethyleneheptamine, 2-(diisopropylamino)ethylamine, pentamethyldiethylenetriamine; alkali metal and alkaline earth metal hydroxides such as LiOH, NaOH, KOH, RbOH, CsOH, Mg(OH)₂, Ca(OH)₂, Sr(OH)₂, Ba(OH)₂; alkoxides, in particular alkali metal alkoxides such as sodium methoxide, potassium methoxide, sodium ethoxide; amides such as sodium amide and potassium amide; and hydrides such as sodium hydride, potassium hydride and calcium hydride.

The preparative process can be carried out in the presence or absence of aprotic solvents. If aprotic solvents are used, solvents or solvent mixtures having a boiling point or boiling range of up to 120° C. at 0.1 MPa are preferred. Examples of such solvents are ethers such as dioxane, tetrahydrofuran, diethyl ether, diisopropyl ether, diethylene glycol dimethyl ether; chlorinated hydrocarbons such as dichloromethane, trichloromethane, tetrachloromethane, 1,2-dichloroethane, trichloroethylene; hydrocarbons such as pentane, n-hexane, hexane isomer mixtures, heptane, octane, naphtha, petroleum ether, benzene, toluene, xylenes; siloxanes, in particular linear dimethylpolysiloxanes having trimethylsilyl end groups and preferably from 0 to 6 dimethylsiloxane units, or cyclic dimethylpolysiloxanes having preferably from 4 to 7 dimethylsiloxane units, for example hexamethyldisiloxane, octamethyltrisiloxane, octamethylcyclotetrasiloxane and decamethylcyclopentasiloxane; esters such as ethyl acetate, butyl acetate, propyl propionate, ethyl butyrate, ethyl isobutyrate; carbon disulfide and nitrobenzene, or mixtures of these solvents.

The temperature in the reaction is preferably from 0° C. to 150° C., particularly preferably from 10° C. to 120° C., in particular from 20° C. to 100° C.

The reaction time is preferably from 1 to 20 hours, particularly preferably from 2 to 10 hours.

The pressure during the reaction is preferably from 0.10 to 10 MPa (abs.), in particular from 0.5 to 2 MPa (abs.).

The phosphonamides of the general formula 1 are preferably isolated by distillation. If a sparingly soluble halide or hydrohalide of a base used is formed, this is preferably separated off beforehand. If a solvent is used, this is preferably separated off before distillation of the phosphonamides of the general formula 1.

The diamines of the general formula 2 can be prepared by reacting diaminoethane or diaminopropane with a chloromethylsilane and a base, as described, for example, in “Journal of Organometallic Chemistry, 268 (1984) 31-38”.

The diamines of the general formula 2 are preferably prepared in a process in which diamines of the general formula 4

H₂N—CH₂—(CH₂)ₙ—NH₂ (4)

are reacted with a silane of the general formula 5

R¹R²R³Si—CH₂Y (5),

where

Y is fluorine, chlorine or bromine and

R¹, R², R³ and n are as defined above.

Y is preferably chlorine.

Preference is given to using a base, in particular a strong base, in the reaction. Preferred bases are the bases which can be used in the preparation of the cyclic phosphonamides of the general formula 1 and additionally carbonates and hydrogencarbonates, for example alkali metal and alkaline earth metal carbonates, e.g. sodium carbonate, potassium carbonate and calcium carbonate.

The preparative process can be carried out in the presence or absence of aprotic solvents. Preferred aprotic solvents are the solvents which can be used in the preparation of the cyclic phosphonamides of the general formula 1.

The reaction temperature in the preparation of the diamines of the general formula 2 is preferably from 20° C. to 200° C., particularly preferably from 40° C. to 150° C.

The reaction time is preferably from 1 hour to 3 days, particularly preferably from 10 hours to 2 days.

The pressure during the reaction is preferably from 0.10 to 10 MPa (abs.), in particular from 0.5 to 2 MPa (abs.).

The diamines of the general formula 2 are preferably isolated by distillation.

The diamines of the general formula 2a

R¹R²R³Si—NH—CH₂—CH₂—CH₂—NH—SiR¹R²R³ (2a)

where R¹, R², R³ are as defined above, are likewise provided by the invention.

The invention also provides an electrolyte containing aprotic solvent, lithium-containing electrolyte salt and silylated cyclic phosphonamides of the general formula 1.

This electrolyte can be used in lithium ion batteries. The electrolyte preferably contains 0.1-10% by weight, in particular 0.5-3% by weight, of phosphonamide of the general formula 1.

The aprotic solvent is preferably selected from among organic carbonates such as dimethyl carbonate, diethyl carbonate, ethyl methyl carbonate, ethylene carbonate, vinylene carbonate, propylene carbonate, butylene carbonate; cyclic and linear esters such as methyl acetate, ethyl acetate, butyl acetate, propyl propionate, ethyl butyrate, ethyl isobutyrate; cyclic and linear ethers such as 2-methyltetrahydrofuran, 1,2-diethoxymethane, THF, dioxane, 1,3-dioxolane, diisopropyl ether, diethylene glycol dimethyl ether; ketones such as cyclopentanone, diisopropyl ketone, methyl isobutyl ketone; lactones such as γ-butyrolactone; sulfolane, dimethyl sulfoxide, formamide, dimethylformamide, 3-methyl-1,3-oxazolidin-2-one and mixtures of these solvents.

Particular preference is given to the above-described organic carbonates.

The electrolyte preferably contains from 0.1 to 3 mol/kg, in particular from 0.5 to 2 mol/kg, of lithium-containing electrolyte salt.

The lithium-containing electrolyte salt is preferably selected from among LiPF₆, LiBF₄, LiClO₄, LiAsF₆, (LiB(C₂O₄)₂, LiBF₂(C₂O₄)), LiSO₃CₓF₂ₓ₊₁, LiN(SO₂CₓF₂ₓ₊₁)₂ and LiC(SO₂CxF₂ₓ₊₁)₃, where x is an integer from 0 to 8, and mixtures thereof.

The electrolytes can, as described in, for example, DE 10027626 A, also contain further additives such as organic isocyanates to reduce the water content, HF scavengers, solubilizers for LiF, organic lithium salts and/or complex salts.

The invention likewise provides a lithium ion battery comprising cathode, anode, separator and the above-described electrolyte.

The negative electrode of the lithium ion battery (cathode) preferably comprises a material which can reversibly take up lithium ions and release them again, for example carbon such as carbon black or graphite. The positive electrode of the lithium ion battery (anode) preferably comprises a lithium-transition metal oxide or a lithium-transition metal phosphate. Preferred transition metals are Ti, V, Cr, Mn, Co, Fe, Ni, Mo, W. Preferred lithium-transition metal oxides are LiCoO₂, LiCoO₂, LiNiO₂, LiMnO₂, LiMnO₂O₄, Li(CoNi)O₂, Li(CoV)O₂, Li(CoFe)O₂. Preferred lithium-transition metal phosphates are LiCoPO₄, Li(NiMn)O₂ and LiNiPO₄. The electrodes of the lithium ion battery can contain further additives which, for example, increase the conductivity, binders, dispersants and fillers. It is possible to use the further additives described in EP 785586 A.

The invention likewise provides for the use of the above-described electrolyte in a lithium ion battery.

All symbols above in the above formulae have their meanings independently of one another in each case. In all formulae, the silicon atom is tetravalent.

In the following examples, unless indicated otherwise, all amounts and percentages are by weight, all pressures are 0.10 MPa (abs.) and all temperatures are 20° C.

### EXAMPLES

### 1. Synthesis of N,N′-bis(trimethylsilylmethyl)-1,3-propanediamine

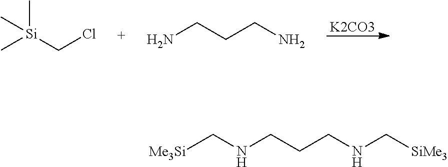

40 g of diaminopropane, 132.4 g of chloromethyltrimethylsilane and 149.2 g of potassium carbonate were introduced into 1 1 of toluene and 160 1 of dimethyl sulfoxide and refluxed for 24 hours. The precipitate was subsequently filtered off and the solvent was removed on a rotary evaporator. The crude product obtained was distilled under reduced pressure (b.p. 68° C./5.0*10⁻² mbar).

¹H NMR (C₆D₆, ppm): =0.04 (s, 18H, Si—CH₃), 1.61 (qu, ³J_{HH}=6.6 Hz, 2H, N—CH₂—CH₂), 2.02 (s, 4H, Si—CH₂—N), 2.67 (t, ³J_{HH}=6.6 Hz, 4H, N—CH₂—CH₂).

²⁹Si {₁H} (C₆D₆, ppm): =−0.9 (s).

### 2. Synthesis of N,N′-bis(trimethylsilylmethyl)-N,N′-trimethylenemethylphosphonic diamide

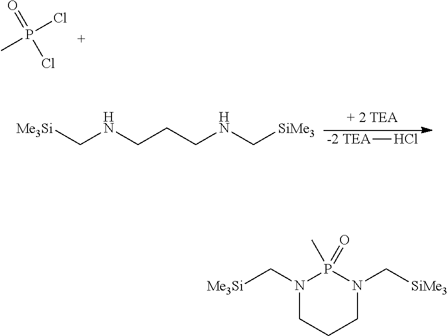

53.8 g of N,N′-bis(trimethylsilylmethyl)-1,3-propanediamine and 44.2 g of triethylamine were placed together with 1 1 of benzene, cooled to 0° C. and 29 g of methylphosphonic dichloride dissolved in 200 ml of benzene were slowly added dropwise. The mixture was subsequently warmed to room temperature and stirred at 60° C. for 6 hours. After the precipitate had been separated off, the filtrate was freed of the solvent on a rotary evaporator and distilled under reduced pressure (b.p. 85-86° C., 2.9*10⁻² mbar). This gave N,N′-bis(trimethylsilylmethyl)-N,N′-trimethylenemethylphosphonic diamide (R¹, R², R³, R⁴=methyl, n=2 in the general formula 1).

¹H NMR (C₆D₆, ppm): =0.11 (s, 18H, Si—CH₃), 0.90-1.00 (m, 1H, N—CH₂—CH₂), 1.07 (d, ²J_{HP=}13.5 Hz, 3H, P—CH₃), 1.74-1.91 (m, 1H, N—CH₂—CH₂), 2.01 (dd,²J_{HH=}15 Hz, ³J_{HP}=7.4 Hz, 2H, Si—CH₂—N), 2.38-2.51 (m, 2H, N—CH₂—CH₂), 2.56-2.75 (m, 2H, N—CH₂—CH₂), 2.63 (dd, ²J_{HH}=15 Hz, ³J_{HP}=8.9 Hz, 2H, Si—CH₂—N).

²⁹Si {¹H} NMR (C₆D₆, ppm): =0.4 (d, ³J_{SiP}=8.0 Hz).

³¹P {¹H} NMR (C₆D₆, ppm): =30.6 (s).

### 3. Use as Electrolyte Additive

1-10% by weight of the phosphonamide of example 2 were mixed into a conventional standard electrolyte. A mixture of ethylene carbonate (EC) and ethyl methyl carbonate (EMC) in a ratio of 3:7 containing 2% of vinylene carbonate (VC) as additive for SEI formation and 1 M LiPF₆ as electrolyte salt was used as standard electrolyte. The phosphonamide was added in proportions by weight of 1,2,3,5 and 10% to this mixture and the resulting electrolytes were electrochemically characterized.

The following were used for the measurement:

METTLER TOLEDO

Seven Multi

(Conductivity TDS/SAL/Resistivity)

Conductivity sensor: INLAB741

The conductivity of the electrolytes is altered only a little by addition of the additive, see table 1:

TABLE 1

| Content of additive (% by weight) | Conductivity (30° C., mS/cm) |
|---|---|
| 0 | 9.9 |
| 1 | 9.9 |
| 2 | 9.6 |
| 3 | 9.6 |
| 5 | 9.2 |
| 10 | 8.7 |

1. A silylated cyclic phosphonamide of the general formula 1 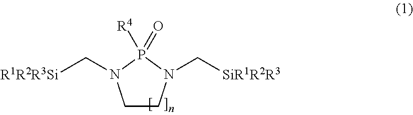
where
R¹ is an unsubstituted or fluorine-substituted alkyl radical having 1-20 carbon atoms,
R², R³ are each an unsubstituted or fluorine-substituted alkyl or alkoxy radical having 1-20 carbon atoms or a siloxy radical having 1-20 silicon atoms, where two or three of the radicals R¹, R², R³ can be joined to one another,
R⁴ is an unsubstituted or fluorine-substituted alkyl radical having 1-20 carbon atoms and
n is 1 or 2.

2. The silylated cyclic phosphonamide as claimed in claim 1, wherein R¹ and R⁴ are members independently selected from the group consisting of methyl, ethyl, n-propyl and isopropyl radicals.

3. The silylated cyclic phosphonamide as claimed in claim 1, wherein R² and R³ are members independently selected from the group consisting of methyl, ethyl, n-propyl, isopropyl, methoxy and ethoxy radicals.

4. A process for preparing silylated cyclic phosphonamides of the general formula 1 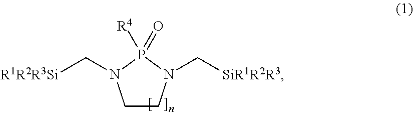
wherein diamines of the general formula 2
R¹R²R³Si—CH₂—NH—CH₂—(CH₂)ₙ—NH—CH₂—SiR¹R²R³ (2)
are reacted with a phosphonic dihalide of the general formula 3
R⁴POX₂ (3),
where
X is fluorine, chloride or bromine,
R¹ is an unsubstituted or fluorine-substituted alkyl radical having 1-20 carbon atoms,
R², R³ are each an unsubstituted or fluorine-substituted alkyl or alkoxy radical having 1-20 carbon atoms or a siloxy radical having 1-20 silicon atoms, where two or three of the radicals R¹, R², R³ can be joined to one another,
R⁴ is an unsubstituted or fluorine-substituted alkyl radical having 1-20 carbon atoms and
n is 1 or 2.

5. The process as claimed in claim 4, wherein X is chlorine.

6. An electrolyte containing
aprotic solvent,
lithium-containing electrolyte salt and
the silylated cyclic phosphonamide of the general formula 1 as claimed in claim 1.

7. The electrolyte as claimed in claim 6, wherein the aprotic solvent is a member selected from the group consisting of organic carbonates, cyclic esters, linear esters, cyclic ethers, linear ethers, ketones, lactones, sulfolanes, dimethyl sulfoxide, formamide, dimethylformamide, 3-methyl-1,3-oxazolidin-2-one and mixtures of these solvents.

8. The electrolyte as claimed in claim 6, wherein the lithium-containing electrolyte salt is a member selected from the group consisting of LiPF₆, LiBF₄, LiClO₄, LiAsF₆, LiSO₃CₓF₂ₓ₊₁, (LiB(C₂O₄)₂, LiBF₂(C₂O₄)), LiN(SO₂CₓF₂ₓ₊₁)₂ and LiC(SO₂CxF₂ₓ₊₁)₃, where x is an integer from 0 to 8, and mixtures thereof.

9. The electrolyte as claimed in claim 6, containing 1-10% by weight of the phosphonamide of the general formula 1.

10. A lithium ion battery comprising a cathode, an anode, a separator and the electrolyte as claimed in claim 6.

11. (canceled)

12. The silylated cyclic phosphonamide as claimed in claim 2, wherein R² and R³ are members independently selected from the group consisting of methyl, ethyl, n-propyl, isopropyl, methoxy and ethoxy radicals.

13. The electrolyte as claimed in claim 7, wherein the lithium-containing electrolyte salt is a member selected from the group consisting of LiPF₆, LiBF₄, LiClO₄, LiAsF₆, LiSO₃CₓF₂ₓ₊₁, (LiB(C₂O₄)₂, LiBF₂(C₂O₄)), LiN(SO₂CₓF₂ₓ₊₁)₂ and LiC(SO₂CxF₂ₓ₊₁)₃, where x is an integer from 0 to 8, and mixtures thereof.

14. The electrolyte as claimed in claim 13, containing 0.1-10% by weight of the phosphonamide of the general formula 1.

15. A lithium ion battery comprising a cathode, an anode, a separator and the electrolyte as claimed in claim 14.
